(19) United States
(12) Patent Application Publication
(10) Pub. No.: US 2026/0302069 A1
(43) Pub. Date: Oct. 1, 2026

(54) MULTILAYER CERAMIC ELECTRONIC COMPONENT

(71) Applicant: Murata Manufacturing Co., Ltd., Nagaokakyo-shi (JP)

(72) Inventors: Kota ZENZAI, Nagaokakyo-shi (JP); Tatsunori YASUDA, Nagaokakyo-shi (JP)

(21) Appl. No.: 19/536,503

(22) Filed: Feb. 11, 2026

(30) Foreign Application Priority Data
Mar. 25, 2025 (JP) 2025-050591

(51) Int. Cl. H01G 4/232

(52) U.S. Cl. CPC H01G 4/232; H01G 4/2325

(57) ABSTRACT

A multilayer ceramic capacitor includes a capacitor body including a multilayer body including a multilayer body second main surface and a pair of outer electrodes spaced apart from each other in a length direction and including a plated layer, a pair of spacers each connected to one of the pair of outer electrodes, and an insulating resin layer on the multilayer body second main surface. The spacer includes a core portion including a material having a melting point higher than that of the plated layer and a low-melting-point surface layer including a material having a melting point equal to or lower than that of the plated layer and partially coats the core portion. The insulating resin layer is in direct contact with the second main surface and an exposed surface of the core portion that is not covered with the low-melting-point surface layer.

### CROSS REFERENCE TO RELATED APPLICATIONS

This application claims the benefit of priority to Japanese Patent Application No. 2025-050591 filed on Mar. 25, 2025. The entire contents of this application are hereby incorporated herein by reference.

### BACKGROUND OF THE INVENTION

### 1. Field of the Invention

The present invention relates to multilayer ceramic electronic components.

### 2. Description of the Related Art

In recent years, a multilayer ceramic capacitor having a high capacitance and a small size has been desired. Such a multilayer ceramic capacitor includes an inner layer portion in which dielectric layers made of a ferroelectric material having a comparatively high dielectric constant and inner electrodes are alternately laminated.

Further, dielectric layers as outer layer portions are disposed on the upper and lower sides of the inner layer portion to form a multilayer body having a rectangular parallelepiped shape, and outer electrodes are disposed on both end surfaces of the multilayer body in a longitudinal direction, thus forming a capacitor body.

Moreover, a known multilayer ceramic capacitor includes a spacer disposed on a side of mounting on a substrate in the capacitor body to reduce or prevent the occurrence of “acoustic noise” (see, for example, International Publication No. WO/2015/098990).

However, when an adhesion force between the capacitor body and the spacer is weak, the spacer is sometimes peeled off, and thus durability when the multilayer ceramic capacitor is mounted has not been sufficient.

### SUMMARY OF THE INVENTION

Example embodiments of the present invention provide multilayer ceramic electronic components each with a high adhesion force between a capacitor body and a spacer and having excellent durability when mounted.

A multilayer ceramic electronic component according to an example embodiment of the present invention includes a capacitor body including a multilayer body including a main surface and a pair of outer electrodes spaced apart from each other in a first direction and including a plated layer, a pair of spacers each connected to a respective one of the pair of outer electrodes, and a coating material on the main surface of the multilayer body, wherein each of the pair of spacers includes a core portion including a material having a melting point higher than a melting pointing of the plated layer, and a low-melting-point surface layer including a material having a melting point equal to or lower than the melting point of the plated layer and partially coating the core portion, and the coating material is in direct contact with the main surface of the multilayer body and an exposed surface of the core portion that is not covered with the low-melting-point surface layer.

According to example embodiments of the present invention, multilayer ceramic electronic components each with a high adhesion force between the capacitor body and the spacer and having excellent durability when mounted are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to a first example embodiment of the present invention.

FIG. 2 is a partial cross-sectional view of the multilayer ceramic capacitor taken along line II-II in FIG. 1.

FIG. 3 is a cross-sectional view of the multilayer ceramic capacitor taken along line III-III in FIG. 1.

FIG. 4 is a partially enlarged view of FIG. 2 and is a cross-sectional view showing a connection state of a spacer and an insulating resin layer.

FIG. 5 is a flowchart for explaining am example of a manufacturing method for a multilayer ceramic capacitor according to an example embodiment of the present invention.

FIGS. 6A to 6D are diagrams for explaining a multilayer body manufacturing step and an outer electrode forming step.

FIGS. 7A to 7C are diagrams for explaining a spacer disposing step and an insulating resin layer forming step.

FIG. 8 is a cross-sectional view showing a connection state of a spacer and an insulating resin layer in a second example embodiment of the present invention.

FIG. 9 is a cross-sectional view showing a connection state of a spacer and an insulating resin layer in a third example embodiment of the present invention.

### DETAILED DESCRIPTION OF THE EXAMPLE EMBODIMENTS

Example embodiments of the present invention will be described in detail below with reference to the drawings.

Multilayer ceramic capacitors 1 are described below as example embodiments of the multilayer ceramic electronic component of the present invention. However, the present invention is not limited thereto. Further, in some cases, the drawings are schematically shown in a simplified manner for describing the content of example embodiments of the present invention, and the ratio of dimensions in a shown component or between shown components does not coincide with the ratio of these dimensions described in the specification. In addition, there are cases in which a component described in the specification is omitted in the drawings, a case in which a component described in the specification is shown with a reduced number of components for simplification, and the like.

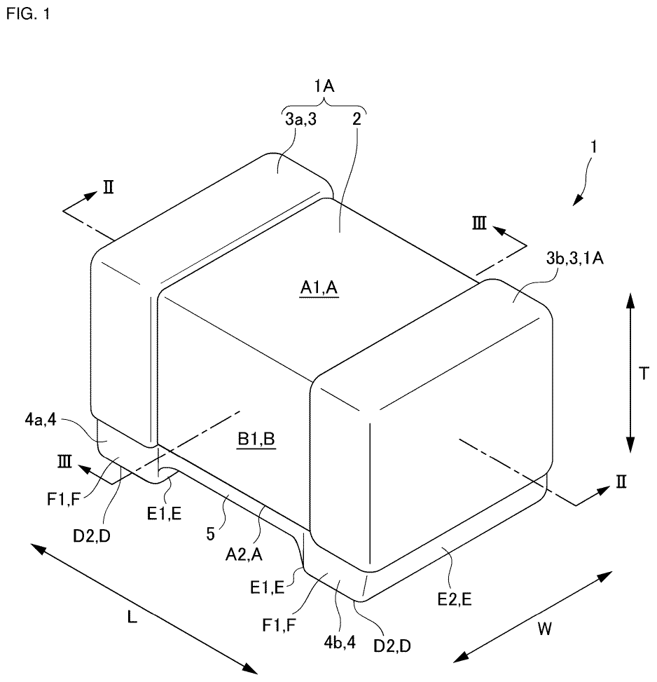

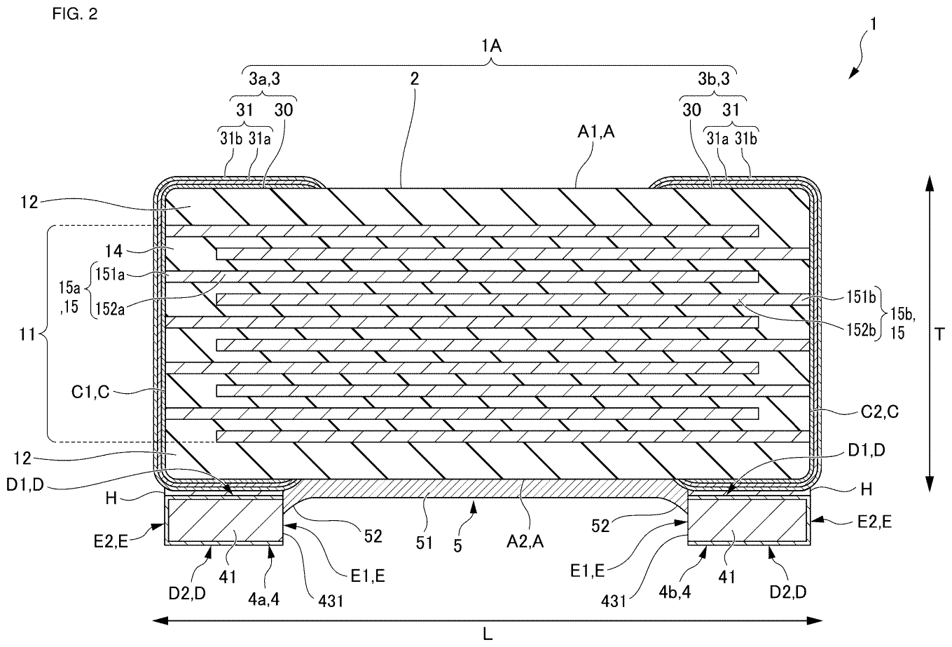

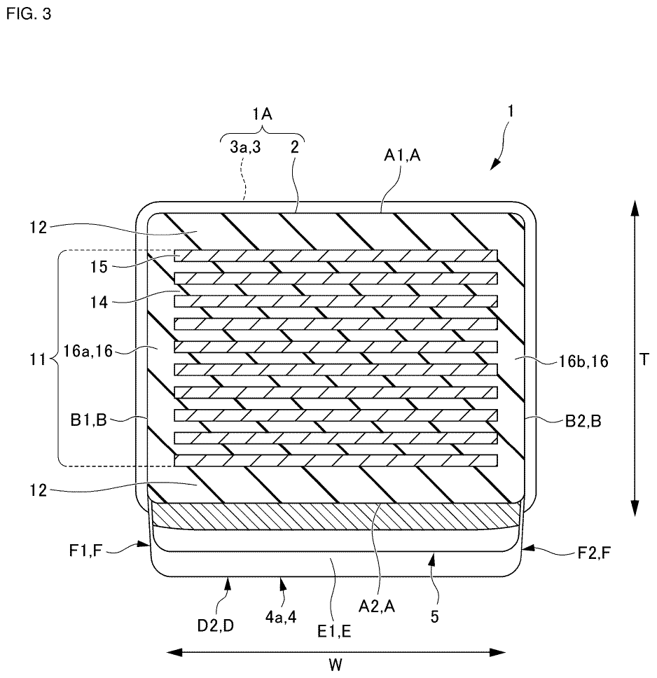

A first example embodiment of the present invention is described below. FIG. 1 is a schematic perspective view of the multilayer ceramic capacitor 1 according to the first example embodiment. FIG. 2 is a partial cross-sectional view of the multilayer ceramic capacitor 1 taken along line II-II in FIG. 1. FIG. 3 is a cross-sectional view of the multilayer ceramic capacitor 1 taken along line III-III in FIG. 1. Line II-II passes through the center of the multilayer ceramic capacitor 1 in a width direction W to be described later, and line III-III passes through the center in a length direction L to be described later.

The multilayer ceramic capacitor 1 includes a capacitor body 1A that has a rectangular or substantially rectangular parallelepiped shape and includes a multilayer body 2 and a pair of outer electrodes 3 disposed at both ends of the multilayer body 2, spacers 4 attached to the capacitor body 1A, and an insulating resin layer 5 (coating material). Further, the multilayer body 2 includes an inner layer portion 11 including a plurality of sets of dielectric layers 14 and inner electrode layers 15.

In the following description, as a term representing an orientation of the multilayer ceramic capacitor 1, a direction in which the pair of outer electrodes 3 are opposed to each other is defined as the length direction L (first direction). A direction in which the dielectric layers 14 and the inner electrode layers 15 are laminated is defined as a lamination direction T (height direction). A direction intersecting both of the length direction L and the lamination direction T is defined as the width direction W (second direction). In the present example embodiment, the width direction W is orthogonal or substantially orthogonal to both the length direction L and the lamination direction T.

Among six outer surfaces of the multilayer body 2, a pair of outer surfaces facing each other in the lamination direction T are defined as a multilayer body first main surface A1 and a multilayer body second main surface A2. Further, a pair of outer surfaces facing each other in the width direction W are defined as a multilayer body first side surface B1 and a multilayer body second side surface B2. In addition, a pair of outer surfaces facing each other in the length direction L are defined as a multilayer body first end surface C1 and a multilayer body second end surface C2.

When it is not required to particularly distinguish between the multilayer body first main surface A1 and the multilayer body second main surface A2, they are collectively referred to as multilayer body main surfaces A. When it is not required to particularly distinguish between the multilayer body first side surface B1 and the multilayer body second side surface B2, they are collectively referred to as multilayer body side surfaces B. When it is not required to particularly distinguish between the multilayer body first end surface C1 and the multilayer body second end surface C2, they are collectively referred to as multilayer body end surfaces C.

The spacers 4 include a pair of members (described later). Among six outer surfaces of the spacer 4, of a pair of outer surfaces facing each other in the lamination direction T, an outer surface on the capacitor body 1A side is defined as a spacer first main surface D1 (first main surface), and an outer surface on the opposite side thereof is defined as a spacer second main surface D2 (second main surface). The spacer first main surface D1 is a surface on the multilayer body 2 side, and the spacer second main surface D2 is a surface on the mounting substrate (not shown) side.

Of a pair of outer surfaces of the spacer 4 facing each other in the length direction L, a surface on the side where the two spacers 4 are opposed to each other is defined as a spacer first end surface E1 (inner surface), and an outer surface on the opposite side thereof is defined as a spacer second end surface E2 (outer surface).

Of a pair of outer surfaces of the spacer 4 facing each other in the width direction W, a surface on a single side in the width direction W is defined as a spacer first side surface F1 (first side surface), and a surface on the opposite side is defined as a spacer second side surface F2 (second side surface).

When it is not required to particularly distinguish between the spacer first main surface D1 and the spacer second main surface D2, they are collectively referred to as spacer main surfaces D. When it is not required to particularly distinguish between the spacer first end surface E1 and the spacer second end surface E2, they are collectively referred to as spacer end surfaces E. When it is not required to particularly distinguish between the spacer first side surface F1 and the spacer second side surface F2, they are collectively referred to as spacer side surfaces F.

The dimensions of the multilayer body 2 are not particularly limited. However, it is preferable that a dimension in the length direction L is, for example, about 1.0 mm or more and about 3.2 mm or less, a dimension in the width direction W is, for example, about 0.5 mm or more and about 1.6 mm or less, and a dimension in the lamination direction T is, for example, about 0.5 mm or more and about 1.6 mm or less.

The multilayer body 2 includes the inner layer portion 11, outer layer portions 12 disposed on both sides of the inner layer portion 11 in the lamination direction T, and side gap portions 16 disposed on both sides of the inner layer portion 11 and the outer layer portions 12 in the width direction W.

The inner layer portion 11 includes a plurality of sets of the dielectric layers 14 and the inner electrode layers 15 alternately laminated along the lamination direction T.

It is preferable that the thickness of the dielectric layer 14 is, for example, about 0.5 μm or less. The dielectric layer 14 is made of a ceramic material. As the ceramic material, for example, a dielectric ceramic including BaTiO₃ as a main component is used. In addition, as the ceramic material, a material obtained by adding at least one of subcomponents such as, for example, a Mn compound, an Fe compound, a Cr compound, a Co compound, or a Ni compound to the main component may be used. It is preferable that the number of dielectric layers 14, including those of the outer layer portions 12, is, for example, 15 or more and 700 or less.

Further, the inner electrode layers 15 include a plurality of first inner electrode layers 15a and a plurality of second inner electrode layers 15b. The first inner electrode layers 15a and the second inner electrode layers 15b are alternately disposed. When it is not required to particularly distinguish between the first inner electrode layers 15a and the second inner electrode layers 15b, they are collectively referred to as the inner electrode layers 15.

The first inner electrode layers 15a each include a first opposing portion 152a opposed to the second inner electrode layer 15b and a first extended portion 151a extending from the first opposing portion 152a toward the multilayer body first end surface C1 side. End portions of the first extended portions 151a are exposed at the multilayer body first end surface C1, and are electrically connected to a first outer electrode 3a to be described later.

The second inner electrode layers 15b each include a second opposing portion 152b opposed to the first inner electrode layer 15a and a second extended portion 151b extending from the second opposing portion 152b to the multilayer body second end surface C2. End portions of the second extended portions 151b are electrically connected to a second outer electrode 3b to be described later.

A charge is accumulated in the first opposing portions 152a of the first inner electrode layers 15a and the second opposing portions 152b of the second inner electrode layers 15b, and characteristics of the capacitor are provided.

As described above, the end portions of the first extended portions 151a of the first inner electrode layers 15a are exposed at the multilayer body first end surface C1, and are electrically connected to the first outer electrode 3a. Further, the end portions of the second extended portions 151b of the second inner electrode layers 15b are exposed at the multilayer body second end surface C2, and are electrically connected to the second outer electrode 3b. This provides a structure in which a plurality of capacitor elements are electrically connected in parallel between the first outer electrode 3a and the second outer electrode 3b.

It is preferable that the inner electrode layer 15 include a metal material typified by, for example, Ni, Cu, Ag, Pd, an Ag—Pd alloy, Au, or the like. It is preferable that the thickness of the inner electrode layer 15 is, for example, about 0.5 μm or more and about 2.0 mm or less. It is preferable that the total number of the inner electrode layers 15, including the first inner electrode layers 15a and the second inner electrode layers 15b, is, for example, 15 or more and 700 or less. Further, for example, a Sn layer may be provided at an interface between the inner electrode layer 15 and the dielectric layer 14.

The shape of the first opposing portion 152a of the first inner electrode layer 15a and the shape of the second opposing portion 152b of the second inner electrode layer 15b are not particularly limited, but are preferably rectangular or substantially rectangular in plan view. However, a corner portion may be rounded in plan view, or the corner portion may be oblique in plan view. Further, the shape may be a tapered shape in which an inclination is provided in a direction toward either end portion in plan view.

The shape of the first extended portion 151a of the first inner electrode layer 15a and the shape of the second extended portion 151b of the second inner electrode layer 15b are not particularly limited, but are preferably rectangular or substantially rectangular in plan view. However, a corner portion may be rounded in plan view, or the corner portion may be oblique in plan view (tapered shape). Further, the shape may be a tapered shape in which an inclination is provided in a direction toward either end portion in plan view.

It is preferable that the outer layer portion 12 is made of the same material as that of the dielectric layer 14 of the inner layer portion 11, but the material is not particularly limited. The amount of an additive may be different between the inner layer portion 11 and the outer layer portion 12. Further, the thickness of the outer layer portion 12 in the lamination direction T is, for example, about 20 μm or less, and is preferably about 10 μm or less.

The side gap portions 16 are disposed on both sides of the inner layer portion 11 and the outer layer portions 12 in the width direction W, and include a first side gap portion 16a defining the multilayer body first side surface B1 of the multilayer ceramic capacitor 1 and a second side gap portion 16b defining the multilayer body second side surface B2 of the multilayer ceramic capacitor 1. The side gap portion 16 can be made of the same material as that of the dielectric layer 14. When the side gap portions 16 are additionally disposed later on both sides of the inner layer portion 11 and the outer layer portions 12 in the width direction W, it is possible to reduce the amount of positional deviation of the end portions of the inner electrode layers 15 in the width direction W. The amount of positional deviation of the end portions of the inner electrode layers 15 in the width direction W is, for example, preferably about 5 μm or less, and more preferably about 0.5 μm or less. The amount of an additive may be different between the inner layer portion 11 and the side gap portion 16. The amount of an additive may be different between the outer layer portion 12 and the side gap portion 16.

The outer electrodes 3 are disposed on the multilayer body end surfaces C on both sides of the multilayer body 2. The outer electrodes 3 cover not only the multilayer body end surfaces C but also portions of the multilayer body main surfaces A and the multilayer body side surfaces B on the multilayer body end surface C side. As described above, the end portions of the extended portions 151 of the inner electrode layers 15 are exposed at the multilayer body end surfaces C, and are electrically connected to the outer electrodes 3. Specifically, the outer electrodes 3 include the first outer electrode 3a disposed on the multilayer body first end surface C1 and the second outer electrode 3b disposed on the multilayer body second end surface C2. When it is not required to particularly distinguish between the first outer electrode 3a and the second outer electrode 3b, they are collectively referred to as the outer electrodes 3.

The outer electrodes 3 each include an underlying electrode layer 30 and a plated layer 31.

The underlying electrode layer 30 is formed, for example, by applying and baking a conductive paste including copper (Cu). The underlying electrode layer 30 may include a glass component or a ceramic material. As shown in FIG. 2, the underlying electrode layers 30 extend not only on the multilayer body end surfaces C on both sides of the multilayer body 2 but also to the multilayer body main surface A side to also cover portions of the multilayer body main surfaces A on the multilayer body end surface C side.

The plated layer 31 includes, for example, a Ni plated layer 31a disposed on a surface of the underlying electrode layer 30 and a Sn plated layer 31b disposed on a surface of the Ni plated layer 31a. The Ni plated layer 31a includes plating of Ni or an alloy including Ni. Similarly to the underlying electrode layers 30, the Ni plated layers 31a extend not only on the multilayer body end surfaces C on both sides of the multilayer body 2 but also to the multilayer body main surface A side to also cover portions of the multilayer body main surfaces A on the multilayer body end surface C side. The Sn plated layer 31b is provided on the surface of the Ni plated layer 31a. The Sn plated layer 31b includes plating of Sn or an alloy including Sn. Although the Ni plated layer 31a and the Sn plated layer 31b have been described as examples of the plated layer 31, the plated layer 31 is not limited thereto.

The spacers 4 include a pair of members as described above, and, specifically, include a first spacer 4a and a second spacer 4b. Hereinafter, when it is not required to distinguish between the first spacer 4a and the second spacer 4b, they are referred to as the spacers 4.

The first spacer 4a is disposed on the multilayer body first end surface C1 side on one side in the length direction L under the multilayer body second main surface A2 of the capacitor body 1A, and the second spacer 4b is disposed on the multilayer body second end surface C2 side on the other side. The first spacer 4a and the second spacer 4b are opposed to each other, and are disposed to be spaced apart by a certain distance.

The spacers 4 are electrically connected to the outer electrodes 3 by solder H (conductive adhesive). Specifically, the spacer first main surfaces D1, which are upper surfaces of the spacers 4, are joined to the outer electrodes 3 with the solder H under the multilayer body second main surface A2, which is a lower surface of the capacitor body 1A. The solder H includes, for example, a metal having a melting point of about 210 °C or higher as a main component. In the present example embodiment, the solder H is manufactured using, for example, high-temperature solder. The high-temperature solder is a metal that includes, for example, Sn, Ag, or Cu and has a remelting temperature of about 300 °C or higher. After being once melted at about 200 °C or higher and then cooled and solidified, the high-temperature solder is not remelted unless heated to about 300 °C or higher. The solder H is not limited thereto. For example, Sn—Sb-based high-temperature solder may be used. When the spacers 4 and the outer electrodes 3 are connected using the solder H, if Sn plated layers are used as the outermost surfaces of the outer electrodes 3 and the spacers 4, portion of the Sn plated layers is absorbed into the solder H and a boundary therebetween becomes unclear in some cases. The conductive adhesive is not limited to the solder H, and, for example, a substance obtained by combining a thermosetting resin and metal powder may be used as the conductive adhesive.

The spacer 4 includes a core portion 41. The core portion 41 is defined by a metal block body including a metallic component as a main component or a substrate such as flame retardant type 4 (FR4). As an example, the core portion 41 includes at least one high-melting-point metal of Cu or Ni. That is, the melting point of the core portion 41 is higher than that of the Sn plated layer 31b. When the core portion is defined by a substrate, for example, it is preferable to use a porous substrate because stress can be reduced. When the core portion 41 is fabricated with a bulk body defined by a metal block body, a substrate, or the like, compared with a case in which the spacer 4 is formed using a metal paste including an organic component and a metallic component, the existence ratio of voids interposed inside can be reduced or be made zero, or sizes of the voids can be reduced. Thus, it is possible to reduce a possibility that the spacer 4 itself fractures.

The spacer 4 includes a low-melting-point surface layer 42. The low-melting-point surface layer 42 includes, for example, Sn. It is preferable that the low-melting-point surface layer 42 has favorable wettability with the solder H (conductive adhesive) used during mounting and to connect the spacer 4 and the outer electrode 3. With the low-melting-point surface layer 42, favorable solderability is achieved at the spacer 4 when the multilayer ceramic capacitor 1 is mounted on a substrate.

The low-melting-point surface layer 42 partially coats the core portion 41. Specifically, the low-melting-point surface layer 42 is disposed at the spacer main surfaces D, the spacer side surfaces F, and the spacer second end surface E2. However, the low-melting-point surface layer 42 does not cover, for example, the spacer first end surface E1. Accordingly, in the spacer first end surface E1, a surface of the core portion 41 is an exposed surface 431. In other words, the exposed surface 431 of the core portion 41 is provided only in the spacer first end surface E1.

As shown in FIG. 1, the insulating resin layer 5 is disposed between the two spacers 4 so as to cover the multilayer body second main surface A2 side of the capacitor body 1A. The spacers 4 are mechanically connected to the multilayer body 2 by the insulating resin layer 5 (described later).

The insulating resin layer 5 includes an insulating resin. A surface of the insulating resin may be coated with a water-repellent treatment agent. Flexural strength is improved by forming the insulating resin layer 5 from the insulating resin. Further, moisture resistance is improved by coating the insulating resin with the water-repellent treatment agent. The insulating resin may include, for example, a ceramic, glass, or the like. The insulating resin layer 5 includes, for example, an epoxy resin as a main component, and a phenolic resin can be combined therewith as a curing agent. When a viscous material such as an epoxy resin is used, the multilayer body 2 and the spacers 4 can be connected more easily. As other curing agents, for example, acid anhydride-based, amine-based, and ester-based curing agents, and the like, can be used. A curing accelerator may further be added to the epoxy resin. The insulating resin layer 5 may include only the water-repellent treatment agent.

As shown in FIG. 2, the insulating resin layer 5 is disposed continuously in the length direction L between the spacer first end surface E1 of one of the spacers 4 and the spacer first end surface E1 of the other spacer 4, and covers the multilayer body second main surface A2 side of the capacitor body 1A (multilayer body 2) and the spacer first end surfaces E1 of the two spacers 4.

However, the insulating resin layer 5 is not necessarily required to be continuous between the first spacer 4a and the second spacer 4b. The insulating resin layer 5 may be discontinuously provided so as to be divided, for example, into a layer coating the spacer first end surface E1 of the first spacer 4a and a portion of the multilayer body second main surface A2 side of the capacitor body 1A (multilayer body 2) and a layer coating the spacer first end surface E1 of the second spacer 4b and a portion of the multilayer body second main surface A2 side of the capacitor body 1A (multilayer body 2).

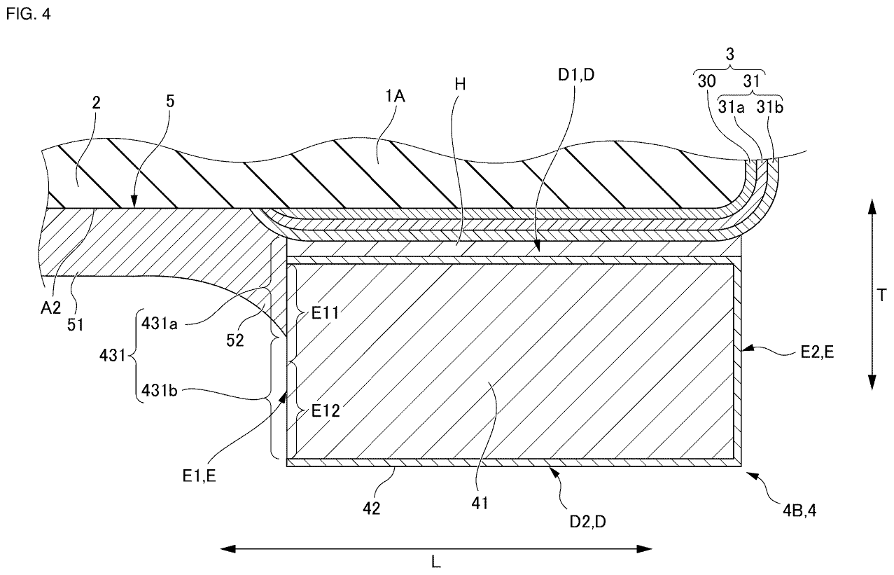

A connection state of the spacer 4 and the insulating resin layer 5 is described with reference to FIG. 4. FIG. 4 is a partially enlarged view of FIG. 2 and is a cross-sectional view showing the connection state of the spacer 4 and the insulating resin layer 5.

The insulating resin layer 5 is connected to the multilayer body second main surface A2 of the multilayer body 2 and the exposed surface 431 of the core portion 41. The insulating resin layer 5 is also connected to the solder H (conductive adhesive). Specifically, the insulating resin layer 5 includes a main layer 51 provided on the multilayer body second main surface A2 and connection portions 52 at both ends of the main layer 51, and the connection portions 52 are each connected to the exposed surface 431 of the core portion 41 and the solder H (conductive adhesive). The connection portions 52 are upward-spread portions extending from the main layer 51. The exposed surface 431 includes a connected surface 431a to which the connection portion 52 is connected on the multilayer body 2 side and a non-connected surface 431b to which the connection portion 52 is not connected on the side spaced away from the multilayer body 2.

As described above, in the present example embodiment, the insulating resin layer 5 and the core portion 41 are in direct contact with each other, that is, the spacer 4 includes a portion where the low-melting-point surface layer 42 is not disposed therebetween. In a case in which, for example, a Sn layer is provided as the low-melting-point surface layer 42 therebetween unlike the present example embodiment, the low-melting-point surface layer 42 melts in association with melting of solder during mounting, and thus the adhesion strength between the insulating resin layer 5 and the spacer 4 is reduced.

More specifically, the insulating resin layer 5 and the core portion 41 are in direct contact in a first region E11 on the multilayer body 2 side, of regions obtained by bisecting the spacer first end surface E1 (exposed surface 431) in the lamination direction T of the spacer 4. That is, the insulating resin layer 5 and the core portion 41 are not connected in a second region E12 on the side opposite to the multilayer body 2, of the regions obtained by bisecting the spacer first end surface E1 (exposed surface 431) in the lamination direction T of the spacer 4. This can save a material of the insulating resin layer 5 while sufficiently ensuring the connection area between the insulating resin layer 5 and the exposed surface 431.

It is preferable that the surface roughness of the exposed surface 431 of the core portion 41 is greater than the surface roughness of the portions of the core portion 41 covered with the low-melting-point surface layer 42. As a result, due to an anchor effect, the adhesion strength between the insulating resin layer 5 and the spacer 4 can be increased. Further, the region connected to the insulating resin layer 5 in the exposed surface 431 of the core portion 41 has a surface roughness greater than that of the region that is not connected to the insulating resin layer 5 in the exposed surface 431 of the core portion 41. As a result, due to the anchor effect, the adhesion strength between the insulating resin layer 5 and the spacer 4 can be increased. Roughening treatment for the core portion 41 may be performed by, for example, chemical etching or the like, or by applying a physical impact. A surface on the spacer second main surface D2 side, of surfaces obtained by bisecting the spacer first end surface E1 in the lamination direction T, may be coated with the low-melting-point surface layer 42. When the surface on the spacer second main surface D2 side, of the surfaces obtained by bisecting the spacer first end surface E1 in the lamination direction T, is coated with the low-melting-point surface layer 42, it is preferable that the surface roughness of the exposed surface 431 is greater than that of the non-exposed surface of the spacer first end surface E1.

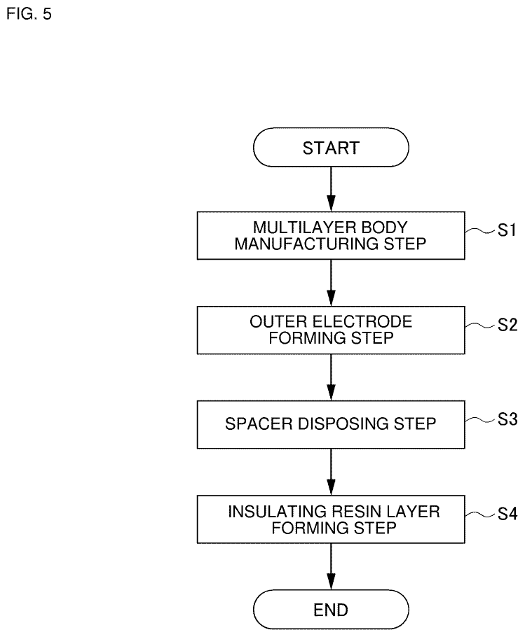

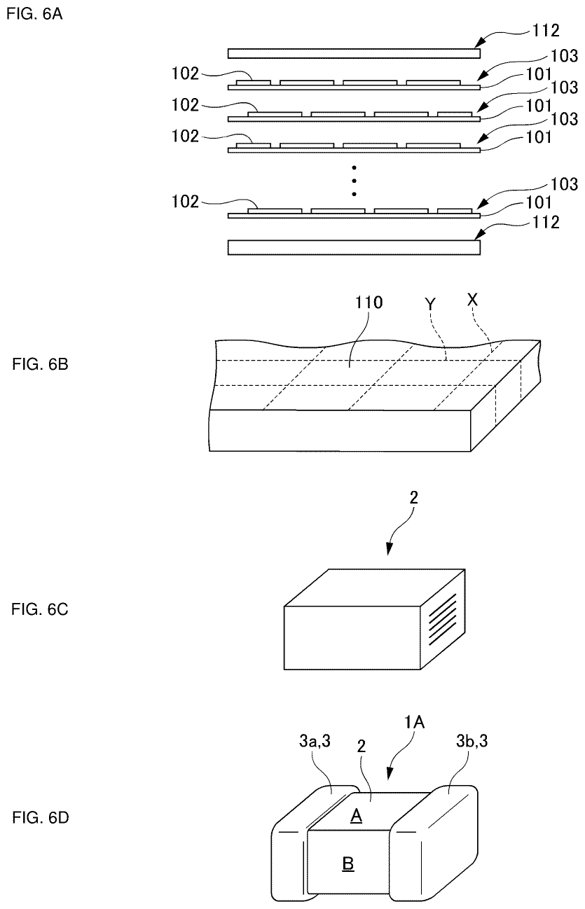

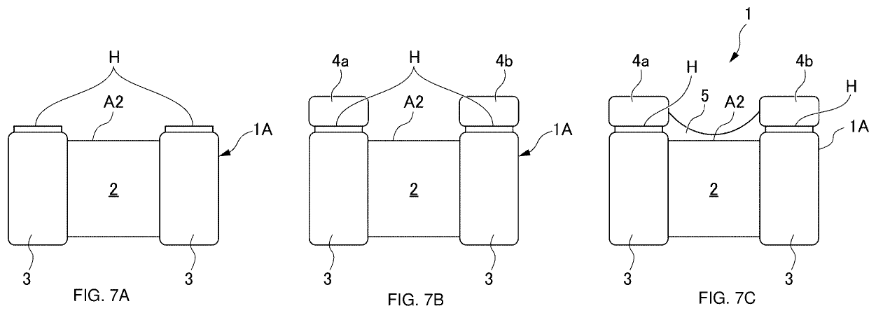

An example of a manufacturing method for the multilayer ceramic capacitor 1 according to an example embodiment of the present invention is described with reference to FIGS. 5 to 7. FIG. 5 is a flowchart for explaining the example of the manufacturing method for the multilayer ceramic capacitor. FIG. 6 is a diagram for explaining a multilayer body manufacturing step and an outer electrode forming step. FIG. 7 is a diagram for explaining a spacer disposing step and an insulating resin layer forming step.

As shown in FIG. 5, the example of the manufacturing method for the multilayer ceramic capacitor 1 includes a multilayer body manufacturing step S1, an outer electrode forming step S2, a spacer disposing step S3, and an insulating resin layer forming step S4.

Ceramic slurry including ceramic powder, a binder, and a solvent is formed in a sheet shape on a surface of a carrier film using, for example, a die coater, a gravure coater, a micro-gravure coater, or the like to fabricate a ceramic green sheet 101 for lamination to define and function as the dielectric layer 14. Next, a conductor paste is printed in a strip shape on the ceramic green sheet 101 for lamination by, for example, screen printing, ink-jet printing, gravure printing, or the like to print a conductive pattern 102 to define and function as the inner electrode layer 15 on a surface of the ceramic green sheet 101 for lamination, thus fabricating a material sheet 103.

Subsequently, as shown in FIG. 6A, a plurality of material sheets 103 are stacked such that the conductive patterns 102 are oriented in the same direction and, between adjacent material sheets 103, the conductive patterns 102 are offset from each other in the length direction L by, for example, about a half pitch. Further, ceramic green sheets 112 for the outer layer portion to define and function as the outer layer portions 12 are stacked on both sides of the plurality of stacked material sheets 103.

The stacked material sheets 103 and the ceramic green sheets 112 for the outer layer portion are pressure-bonded by, for example, isostatic pressing or the like to fabricate a mother block 110 shown in FIG. 6B.

Next, the mother block 110 is cut along cutting lines X shown in FIG. 6B and cutting lines Y intersecting the cutting lines X to manufacture a plurality of multilayer bodies 2 shown in FIG. 6C.

Subsequently, the underlying electrode layers 30 are formed by applying a conductive paste including, for example, copper (Cu) to the multilayer body end surfaces C of the multilayer body 2 and baking the conductive paste. The underlying electrode layers 30 are formed so as to extend not only on the multilayer body end surfaces C on both sides of the multilayer body 2 but also to the multilayer body main surface A side and the multilayer body side surface B side of the multilayer body 2 to also cover portions of the multilayer body main surfaces A on the multilayer body end surface C side. Next, for example, the Ni plated layers 31a and the Sn plated layers 31b disposed on surfaces of the Ni plated layers 31a are formed as the plated layer 31 over surfaces of the underlying electrode layers 30, thus manufacturing the capacitor body 1A shown in FIG. 6D.

When the core portion 41 is formed of a metal block body including a metal as a main component, a metal plate having a predetermined thickness is first prepared. Thereafter, the metal plate is diced into a plate having a predetermined size, and then a surface layer is formed on a surface of the metal plate. The dicing of the metal plate may be performed, for example, so as to form a plate having a dimension close to the dimension of one multilayer ceramic capacitor in the length direction L, or having a dimension close to the total dimension of two multilayer ceramic capacitors in the width direction W, or having a dimension close to the total dimension of two outer electrodes disposed in one multilayer ceramic capacitor in the length direction L. It is preferable that the surface layer is formed by plating, for example. The surface layer may be formed before the dicing, or may be formed after the dicing. The surface layer may include two or more layers. Finally, treatment for forming the low-melting-point surface layer 42 (for example, Sn plating) is performed to form the low-melting-point surface layer 42.

When the core portion 41 is formed of a substrate such as FR4, a substrate having a predetermined thickness is first prepared. Thereafter, the substrate is diced into a substrate having a predetermined size, and then a surface layer is formed on a surface of the substrate. The dicing of the substrate may be performed, for example, so as to form a substrate having a dimension close to the dimension of one multilayer ceramic capacitor in the length direction L, or having a dimension close to the total dimension of two multilayer ceramic capacitors in the width direction W, or having a dimension close to the total dimension of two outer electrodes disposed in one multilayer ceramic capacitor in the length direction L. It is preferable that the surface layer is formed of, for example, a thin film of copper or the like and a plated layer. The surface layer may be formed before the above dicing, or may be formed after the above dicing. The surface layer may include two or more layers. Finally, treatment for forming the low-melting-point surface layer 42 (for example, Sn plating) is performed to form the low-melting-point surface layer 42.

First, as shown in FIG. 7A, the solder H in a cream state is disposed on the capacitor body 1A by, for example, screen printing or the like. Next, as shown in FIG. 7B, the first spacer 4a and the second spacer 4b are placed over the capacitor body 1A. Specifically, the first spacer 4a and the second spacer 4b are joined to the first outer electrode 3a and the second outer electrode 3b, respectively, of the capacitor body 1A. As another example, the following process may be used. A plate resulting from dicing is diced into a plate having a dimension close to the dimension of one multilayer ceramic capacitor in the length direction L, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is disposed on the first spacer 4a and the second spacer 4b by, for example, screen printing or the like, and then the capacitor body 1A is placed thereon. Thereafter, reflow is performed to join the first spacer 4a and the second spacer 4b to the capacitor body 1A.

Alternatively, as another example, the following process may be used. A plate resulting from dicing is diced into a plate having a dimension close to the total dimension of two multilayer ceramic capacitors in the width direction W, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is disposed on the first spacer 4a and the second spacer 4b by, for example, screen printing or the like, and then the capacitor body 1A is placed thereon. Thereafter, reflow is performed to join the first spacer 4a and the second spacer 4b to the capacitor body 1A. By joining the capacitor bodies 1A to the plate before forming the first spacer 4a and the second spacer 4b, and performing dicing between the capacitor bodies 1A arranged in the width direction W, the multilayer ceramic capacitors including the first spacer 4a and the second spacer 4b may be formed. In this case, the plate before forming the first spacer 4a and the second spacer 4b has a size larger than the total dimension of two multilayer ceramic capacitors in the width direction W. Further, the dimension of the first spacer 4a and the second spacer 4b in the width direction W may be larger than the dimension of the capacitor body 1A.

Alternatively, as another example, the following process may be used. A plate resulting from dicing is diced into a plate having a dimension close to the total dimension of two outer electrodes disposed in one multilayer ceramic capacitor in the length direction L, and thereafter the low-melting-point surface layer 42 is formed. Thereafter, after being held on a holding substrate, the plate is diced to form the first spacer 4a and the second spacer 4b. Thereafter, while the first spacer 4a and the second spacer 4b remain held on the holding substrate, the solder H in a cream state is disposed on the first spacer 4a and the second spacer 4b by, for example, screen printing or the like, and then the capacitor body 1A is placed thereon. Thereafter, reflow is performed to join the first spacer 4a and the second spacer 4b to the capacitor body 1A. By joining the capacitor bodies 1A to the plate before forming the first spacer 4a and the second spacer 4b, and performing dicing between the capacitor bodies 1A arranged in the length direction L, the multilayer ceramic capacitors including the first spacer 4a and the second spacer 4b may be formed. In this case, the plate before forming the first spacer 4a and the second spacer 4b has a size larger than the total dimension of two outer electrodes disposed in one multilayer ceramic capacitor in the length direction L. Further, a portion of the first spacer 4a and the second spacer 4b may be disposed so as to protrude from the capacitor body 1A when viewed in the lamination direction T.

Next, as shown in FIG. 7C, a resin material layer that becomes the insulating resin layer 5 is formed on the multilayer body second main surface A2 portion of the capacitor body 1A by using a dispenser or squeegee printing, for example. At this time, the amount of upward spreading to the spacer can be varied depending on the amount and viscosity of the insulating resin.

By putting the capacitor body 1A to which the resin material layer has been applied in an environment at, for example, about 180 °C for about 60 minutes, the resin material layer is thermally cured. Although a thermosetting resin is used as the resin material layer in the present example embodiment, the resin material layer is not limited thereto and, for example, a photocurable resin may be used.

As a result, the resin material layer becomes the cured insulating resin layer 5, and finally, the multilayer ceramic capacitor 1 is obtained. Between the spacer disposing step S3 and the insulating resin layer forming step S4, a core portion roughening treatment step or a low-melting-point surface layer removal step may be provided.

As described above, with the multilayer ceramic capacitor 1 according to the present example embodiment, because the spacers 4 are attached to the capacitor body 1A, excessive upward spreading of solder used during mounting to the capacitor body 1A can be reduced or prevented by the spacers 4, and vibration transmitted to the mounting substrate can be reduced or prevented.

Further, with the multilayer ceramic capacitor 1 according to the present example embodiment, the insulating resin layer 5 is attached between the spacers 4. Accordingly, the adhesion force between the capacitor body 1A and the spacers 4 can be increased, and separation of the spacers 4 from the capacitor body 1A can be prevented. In addition, resistance to the occurrence of a crack or the like in the multilayer ceramic capacitor 1 when bending or the like occurs in the mounting substrate, that is, substrate bending resistance, is improved.

In the present example embodiment, the insulating resin layer 5 and the core portion 41 are in direct contact with each other, that is, the low-melting-point surface layer 42 is not disposed therebetween. Accordingly, a high adhesion force between the insulating resin layer 5 and the spacers 4 can be ensured. As a result, the multilayer ceramic capacitor 1 having excellent durability when mounted is achieved.

In the above first example embodiment, the low-melting-point surface layer 42 is not provided on the inner surface of the core portion 41 (spacer first end surface E1 of the spacer 4). However, the low-melting-point surface layer 42 may be provided on a portion of the inner surface of the core portion 41 (portion where the insulating resin layer 5 is not provided).

In the above first example embodiment, the low-melting-point surface layer 42 is provided over the entirety or substantially the entirety of each of the spacer main surfaces D, the spacer side surfaces F, and the spacer second end surface E2. However, the low-melting-point surface layer 42 may be absent from a portion or the entirety or substantially the entirety of each of the spacer main surfaces D, the spacer side surfaces F, and the spacer second end surface E2. That is, the core portion 41 may be exposed at each of the respective surfaces other than the spacer first end surface E1 of the spacer 4.

In the first example embodiment, the exposed surface 431, which is not covered with the low-melting-point surface layer, in the core portion 41 is provided in the spacer first end surface E1, which is the inner surface of the spacer 4. However, the exposed surface of the core portion 41 is not limited to the spacer first end surface E1.

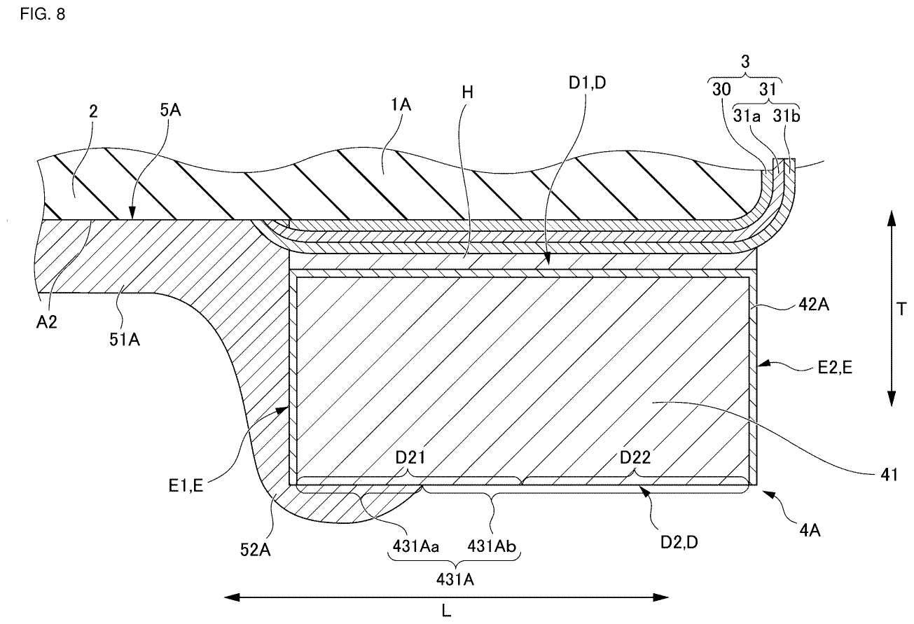

With reference to FIG. 8, a second example embodiment of the present invention is described as an example in which the surface in which the exposed surface 431 of the core portion 41 is provided is different from that of the first example embodiment. FIG. 8 is a cross-sectional view showing a connection state of a spacer 4A and an insulating resin layer 5A in the second example embodiment. The basic configuration of the second example embodiment is the same or substantially the same as that of the first example embodiment. Thus, different points are mainly described below.

As shown in FIG. 8, the spacer 4A includes a low-melting-point surface layer 42A. The low-melting-point surface layer 42A includes, for example, Sn. It is preferable that the low-melting-point surface layer 42A has favorable wettability with the solder H (conductive adhesive) used during mounting and to connect the spacer 4A and the outer electrode 3. With the low-melting-point surface layer 42A, favorable solderability is achieved at the spacer 4A when the multilayer ceramic capacitor 1 is mounted on a substrate.

The low-melting-point surface layer 42A partially coats the core portion 41. Specifically, the low-melting-point surface layer 42A is disposed at the spacer first main surface D1, the spacer side surfaces F, and the spacer end surfaces E. However, the low-melting-point surface layer 42A does not cover the spacer second main surface D2. Accordingly, an exposed surface 431A is provided in the spacer second main surface D2 on the core portion 41. In other words, the exposed surface 431A of the core portion 41 is provided only in the spacer second main surface D2.

The insulating resin layer 5A is connected to the multilayer body second main surface A2 of the multilayer body 2 and the exposed surface 431A of the core portion 41. The insulating resin layer 5A is also connected to the solder H (conductive adhesive). Specifically, the insulating resin layer 5A includes a main layer 51A provided on the multilayer body second main surface A2 and connection portions 52A at both ends of the main layer 51A, and the connection portions 52A are each connected to the exposed surface 431A of the core portion 41 and the solder H (conductive adhesive). The connection portions 52A each extend along the spacer first end surface E1 of the spacer 4A to reach the spacer second main surface D2. The connection portions 52A are upward-spread portions extending from the main layer 51A. The exposed surface 431A includes a connected surface 431Aa to which the connection portion 52A is connected on the spacer first end surface E1 side and a non-connected surface 431Ab to which the connection portion 52A is not connected on the spacer second end surface E2 side.

As described above, in the present example embodiment, the insulating resin layer 5A and the core portion 41 are in direct contact with each other, that is, the spacer 4A includes a portion where the low-melting-point surface layer 42A is not disposed therebetween. In a case in which, for example, a Sn layer is disposed as the low-melting-point surface layer 42A therebetween unlike the present example embodiment, the low-melting-point surface layer 42A melts in association with melting of solder during mounting, and thus the adhesion strength between the insulating resin layer 5A and the spacer 4A is reduced.

More specifically, the insulating resin layer 5A and the core portion 41 are in direct contact only in a portion of a first region D21 on the spacer first end surface E1 side, of regions obtained by bisecting the spacer second main surface D2 (exposed surface 431A) in the length direction L. That is, the insulating resin layer 5A and the core portion 41 are not in direct contact in a second region D22 on the side opposite to the spacer first end surface E1, of the regions obtained by bisecting the spacer second main surface D2 (exposed surface 431A) in the length direction L. This can save a material of the insulating resin layer 5A while sufficiently ensuring the connection area between the insulating resin layer 5A and the exposed surface 431A.

It is preferable that the surface roughness of the exposed surface 431A of the core portion 41 is greater than the surface roughness of the portions of the core portion 41 covered with the low-melting-point surface layer 42A. As a result, due to an anchor effect, the adhesion strength between the insulating resin layer 5A and the spacer 4A can be increased. Further, the region connected to the insulating resin layer 5A in the exposed surface 431A of the core portion 41 has a surface roughness greater than that of the region that is not connected to the insulating resin layer 5A in the exposed surface 431A of the core portion 41. As a result, due to the anchor effect, the adhesion strength between the insulating resin layer 5A and the spacer 4A can be increased. Roughening treatment for the core portion 41 may be performed by, for example, chemical etching or the like, or by applying a physical impact.

In the above second example embodiment, the low-melting-point surface layer 42A is not provided on a main surface of the core portion 41 (spacer second main surface D2 of the spacer 4A). A surface on the spacer second end surface E2 side, of surfaces obtained by bisecting the spacer second main surface D2 in the length direction L, may be coated with the low-melting-point surface layer 42A. Further, mounting solder may be provided so as to be in contact with the insulating resin layer 5A disposed on the spacer second main surface D2 after mounting. It becomes difficult for the solder to melt and flow toward the center in the length direction L beyond the insulating resin layer 5A disposed on the spacer second main surface D2, and thus the possibility of a short circuit can be reduced. When the surface on the spacer second end surface E2 side, of the surfaces obtained by bisecting the spacer second main surface D2 in the length direction L, is coated with the low-melting-point surface layer 42A, it is preferable that the surface roughness of the exposed surface 431A is greater than that of the non-exposed surface of the spacer second main surface D2. Further, in this case, when the core portion 41 is made of an insulating material or is made of a material including Ni as a main component, there is a possibility that the solder used during mounting does not sufficiently spread on the surface of the core portion 41. Thus, it is preferable that, for example, in the second region D22, a portion of the core portion 41 is coated with a Cu film or a material including Cu as a main component is used for the core portion 41.

In the above second example embodiment, the low-melting-point surface layer 42A is provided over the entirety or substantially the entirety of each of the spacer first main surface D1, the spacer side surfaces F, and the spacer end surfaces E. However, the low-melting-point surface layer 42A may be absent from a portion or an entirety or substantially the entirety of each of the spacer first main surface D1, the spacer side surfaces F, and the spacer end surfaces E. That is, the core portion 41 may be exposed at each of the respective surfaces other than the spacer second main surface D2 of the spacer 4A.

In the first example embodiment, the exposed surface 431, which is not covered with the low-melting-point surface layer 42, in the core portion 41 is provided in the spacer first end surface E1, which is the inner surface of the spacer 4. However, the exposed surface 431 of the core portion 41 is not limited to the spacer first end surface E1 of the spacer 4.

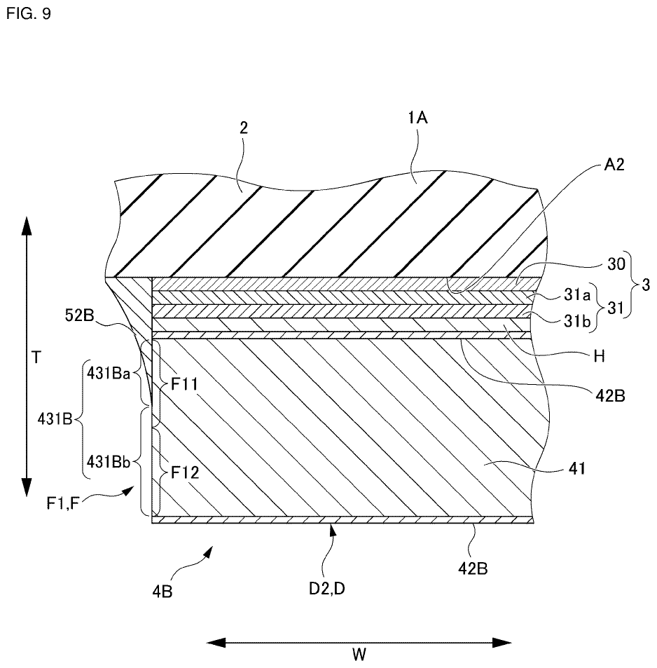

With reference to FIG. 9, a third example embodiment of the present invention is described as an example in which the surface in which the exposed surface 431 of the core portion 41 is provided is different from that of the first example embodiment. FIG. 9 is a cross-sectional view showing a connection state of a spacer 4B and an insulating resin layer 5B in the third example embodiment. The basic configuration of the third example embodiment is the same or substantially the same as that of the first example embodiment. Thus, different points are mainly described below.

As shown in FIG. 9, the spacer 4B includes a low-melting-point surface layer 42B (low-melting-point surface layer). The low-melting-point surface layer 42B includes, for example, Sn. It is preferable that the low-melting-point surface layer 42B has favorable wettability with the solder H (conductive adhesive) used during mounting and to connect the spacer 4B and the outer electrode 3. With the low-melting-point surface layer 42B, favorable solderability is achieved at the spacer 4B when the multilayer ceramic capacitor 1 is mounted on a substrate.

The low-melting-point surface layer 42B partially coats the core portion 41. Specifically, the low-melting-point surface layer 42B is disposed at the spacer main surfaces D, the spacer second side surface F2 (second side surface), and the spacer end surfaces E. However, the low-melting-point surface layer 42B does not cover the spacer first side surface F1 (first side surface). Accordingly, in the spacer first side surface F1, a surface of the core portion 41 is an exposed surface 431B. In other words, the exposed surface 431B of the core portion 41 is provided only in the spacer first side surface F1.

The insulating resin layer 5B is connected to the multilayer body second main surface A2 of the multilayer body 2 and the exposed surface 431B on the core portion 41. The insulating resin layer 5B is also connected to the solder H (conductive adhesive). Specifically, the insulating resin layer 5B includes a main layer 51B provided on the multilayer body second main surface A2 and connection portions 52B provided at both ends of the main layer 51B, and the connection portions 52B are each connected to the exposed surface 431B of the core portion 41 and the solder H (conductive adhesive). The connection portions 52B are upward-spread portions extending from the main layer 51B. The exposed surface 431B includes a connected surface 431Ba to which the connection portion 52B is connected on the multilayer body 2 side and a non-connected surface 431Bb to which the connection portion 52B is not connected on the side away from the multilayer body 2.

As described above, in the present example embodiment, the insulating resin layer 5B and the core portion 41 are in direct contact with each other, that is, the spacer 4B includes a portion where the low-melting-point surface layer 42B is not disposed therebetween. In a case in which, for example, a Sn layer is provided as the low-melting-point surface layer 42B therebetween unlike the present example embodiment, the low-melting-point surface layer 42B melts in association with melting of solder during mounting, and thus the adhesion strength between the insulating resin layer 5B and the spacer 4B is reduced.

More specifically, the insulating resin layer 5B and the core portion 41 are in direct contact in a first region F11 on the spacer first main surface D1 side, of regions obtained by bisecting the spacer first side surface F1 (exposed surface 431B) in the lamination direction T. That is, the insulating resin layer 5B and the core portion 41 are not connected in a second region F12 on the side opposite to the spacer first main surface D1, of the regions obtained by bisecting the spacer first side surface F1 (exposed surface 431B) in the lamination direction T. This can save a material of the insulating resin layer 5B while sufficiently ensuring the connection area between the insulating resin layer 5B and the exposed surface 431B. Further, it is also possible to use a configuration in which the insulating resin layer 5B and the core portion 41 are in direct contact in a region on the spacer first end surface E1 side, of regions obtained by bisecting the spacer first side surface F1 (exposed surface 431B) in the length direction L, and are not in direct contact in a region on the spacer second end surface E2 side.

It is preferable that the surface roughness of the exposed surface 431B of the core portion 41 is greater than the surface roughness of the portions of the core portion 41 covered with the low-melting-point surface layer 42B. As a result, due to an anchor effect, the adhesion strength between the insulating resin layer 5B and the spacer 4B can be increased. Further, the region connected to the insulating resin layer 5B in the exposed surface 431B of the core portion 41 has a surface roughness greater than that of the region that is not connected to the insulating resin layer 5B in the exposed surface 431B of the core portion 41. As a result, due to the anchor effect, the adhesion strength between the insulating resin layer 5B and the spacer 4B can be increased. Roughening treatment for the core portion 41 may be performed by, for example, chemical etching or the like, or by applying a physical impact.

In the above third example embodiment, the low-melting-point surface layer 42B is not provided on a side surface of the core portion 41 (spacer first side surface F1 of the spacer 4B). A surface on the spacer second main surface D2 side, of surfaces obtained by bisecting the spacer first side surface F1 in the lamination direction T, may be coated with the low-melting-point surface layer 42B. Further, mounting solder may be provided so as to be in contact with the insulating resin layer 5B disposed on the spacer first side surface F1 after mounting. It becomes difficult for the solder to melt and flow toward the capacitor body 1A side in the lamination direction T beyond the insulating resin layer 5B disposed on the spacer first side surface F1, and thus the possibility of excessive upward spreading of the solder can be reduced. When the surface on the spacer second main surface D2 side, of the surfaces obtained by bisecting the spacer first side surface F1 in the lamination direction T, is coated with the low-melting-point surface layer 42B, it is preferable that the surface roughness of the exposed surface 431B is greater than that of the non-exposed surface of the spacer first side surface F1.

In the third example embodiment, the low-melting-point surface layer 42B is provided over the entirety or substantially the entirety of each of the spacer main surfaces D, the spacer second side surface F2, and the spacer end surfaces E. However, the low-melting-point surface layer 42B may be absent from a portion or an entirety or substantially the entirety of each of the spacer main surfaces D, the spacer second side surface F2, and the spacer end surfaces E. That is, the core portion 41 may be exposed at each of the respective surfaces other than the spacer first side surface F1 of the spacer 4B. Further, the configuration is not limited thereto, and the exposed surface 431B may be provided in the spacer first side surface F1 and the spacer second side surface F2. In this case, the same or similar advantageous effects can also be obtained in the spacer second side surface F2.

Although example embodiments of the present invention have been described above, the present invention is not limited to the example embodiments, and various modifications can be made without departing from the scope and gist of the present invention. In particular, the example embodiments and the modifications described in the present specification can be combined in any manner as required.

The outer electrode may include a combination of Ni with an additive material and Cu/Ni/Sn plating, for example.

The outer electrode may include a combination of Ni with an additive material, Cu with a glass component, and Ni/Sn plating, for example.

The outer electrode may include a combination of Cu with a glass component, a resin electrode, and Ni/Sn plating, for example.

The shape of the spacer is not particularly limited, and the spacer may have a shape in which an outer side portion in the length direction is cut away. This makes it possible to prevent excessive upward spreading of solder to the multilayer ceramic capacitor. Further, a concave portion may extend from the spacer second main surface D2 toward the spacer first main surface D1. It is preferable that the low-melting-point surface layer 42 is disposed on a circumferential surface of the concave portion provided in the spacer 4. This can reduce or prevent excessive solder upward spreading, to the capacitor body 1A, of solder used during mounting. At this time, the insulating resin layer 5 may extend so as to cover a portion of the concave portion or an entirety of the concave portion. In this case, because a cavity is provided in the spacer 4, vibration can be damped by the cavity portion.

Further, a concave portion may extend from the spacer first main surface D1 toward the spacer second main surface D2. It is preferable that the low-melting-point surface layer 42 is provided on a circumferential surface of the concave portion provided in the spacer 4. This can reduce or prevent excessive solder upward spreading, to the capacitor body 1A, of solder used in connecting the spacer 4 and the capacitor body 1A.

Further, the spacer 4 may have a shape in which a hole extends from the spacer first main surface D1 to the spacer second main surface D2. It is preferable that the low-melting-point surface layer 42 is provided on a circumferential surface of the hole provided in the spacer 4. This can reduce or prevent excessive solder upward spreading, to the capacitor body 1A, of solder used during mounting or when connecting the spacer 4 and the capacitor body 1A. At this time, the insulating resin layer 5 may extend so as to cover a portion of the hole or the hole. A gap may be provided between the solder H entering the hole from the spacer first main surface D1 and the insulating resin layer 5 extending from the spacer second main surface D2. In this case, because a cavity is provided in the spacer 4, vibration can be damped by the cavity portion.

The size of the spacer 4 in a view along the lamination direction T is not particularly limited. The spacer 4 may be smaller than the area of the outer electrode 3 connected through solder, and may be spaced apart from an end portion of the outer electrode 3 on the outer side in the length direction L. This can prevent excessive upward spreading of the solder to the capacitor body 1A.

Further, when the outer electrode 3 is bisected in the length direction L, the spacer 4 may be located near the outer electrode 3 on the inner side in the length direction L. This can prevent excessive upward spreading of the solder to the capacitor body 1A.

The shape of the insulating resin layer 5 in plan view is not limited to a rectangular or substantially rectangular shape. The edges of the insulating resin layer 5 extending in the length direction L may be linear. Alternatively, the edges may have a curved shape convex outward in the width direction W, or have a curved shape concave inward in the width direction W.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor body including a multilayer body including a main surface and a pair of outer electrodes spaced apart from each other in a first direction and including a plated layer;
a pair of spacers each connected to a respective one of the pair of outer electrodes; and
a coating material on the main surface of the multilayer body; wherein
each of the pair of spacers includes:
a core portion including a material having a melting point higher than a melting pointing of the plated layer; and
a low-melting-point surface layer including a material having a melting point equal to or lower than the melting point of the plated layer and partially coats the core portion; and
the coating material is in direct contact with the main surface of the multilayer body and an exposed surface of the core portion that is not covered with the low-melting-point surface layer.

2. The multilayer ceramic electronic component according to claim 1, further comprising:
a conductive adhesive connecting each of the pair of outer electrodes to a respective one of the pair of spacers.

3. The multilayer ceramic electronic component according to claim 2, wherein the coating material is in direct contact with the main surface of the multilayer body, the conductive adhesive, and the exposed surface of the core portion.

4. The multilayer ceramic electronic component according to claim 1, wherein the exposed surface of the core portion is located in inner surfaces opposed to each other in the pair of spacers and is in direct contact with the coating material.

5. The multilayer ceramic electronic component according to claim 4, wherein the coating material and the core portion are in direct contact in a region on the capacitor body side, of regions obtained by bisecting the inner surface in a height direction of the spacer.

6. The multilayer ceramic electronic component according to claim 4, wherein the low-melting-point surface layer is not located on the inner surface.

7. The multilayer ceramic electronic component according to claim 1, wherein
the spacer includes a first main surface and a second main surface facing each other in a height direction in which the capacitor body and the spacer are arranged, a first side surface and a second side surface facing each other in a second direction orthogonal or substantially orthogonal to the first direction in which the pair of spacers are arranged and the height direction, and an inner surface on a side where the pair of spacers are opposed to each other;
the first main surface is located on the capacitor body side; and
the exposed surface is located in the second main surface and is in direct contact with the coating material.

8. The multilayer ceramic electronic component according to claim 7, wherein the coating material and the core portion are in direct contact in a region on the inner surface side, of regions obtained by bisecting the second main surface in the first direction.

9. The multilayer ceramic electronic component according to claim 1, wherein
the spacer includes a first main surface and a second main surface facing each other in a height direction in which the capacitor body and the spacer are arranged, a first side surface and a second side surface facing each other in a second direction orthogonal or substantially orthogonal to the first direction in which the pair of spacers are arranged and the height direction, and an inner surface on a side where the pair of spacers are opposed to each other; and
the exposed surface of the core portion is located in the first side surface and is in direct contact with the coating material.

10. The multilayer ceramic electronic component according to claim 9, wherein the coating material and the core portion are in direct contact with each other in a region on the capacitor body side, of regions obtained by bisecting the first side surface in the height direction.

11. The multilayer ceramic electronic component according to claim 9, wherein the low-melting-point surface layer is not located on the first side surface.

12. The multilayer ceramic electronic component according to claim 1, wherein a surface roughness of the exposed surface of the core portion is greater than a surface roughness of a portion of the core portion covered with the low-melting-point surface layer.

13. The multilayer ceramic electronic component according to claim 1, wherein a region connected to the coating material in the core portion has a surface roughness greater than a surface roughness of a region that is not connected to the coating material in the core portion.

14. The multilayer ceramic electronic component according to claim 1, wherein the core portion includes a metal block body including a metallic main component.

15. The multilayer ceramic electronic component according to claim 1, wherein the core portion includes a flame retardant type 4 substrate.

16. The multilayer ceramic electronic component according to claim 1, wherein the material of the core portion includes Cu or Ni.

17. The multilayer ceramic electronic component according to claim 1, wherein the low-melting-point surface layer includes Sn.

18. The multilayer ceramic electronic component according to claim 1, wherein the coating material includes an insulating resin layer.

19. The multilayer ceramic electronic component according to claim 18, wherein the insulating resin layer includes an epoxy resin.

20. The multilayer ceramic electronic component according to claim 18, wherein the insulating resin layer is coated with a water-repellant treatment agent.
